(19) United States
(12) Patent Application Publication
(10) Pub. No.: US 2009/0193953 A1
(43) Pub. Date: Aug. 6, 2009

(54) VEGETABLE CUTTING APPARATUS

(76) Inventors: Bruno Romeo, Woodforde (AU); Nazzarena Romeo, Woodforde (AU)

Correspondence Address: WEINER & BURT, P.C., 635 N US-23, POB 186, HARRISVILLE, MI, 48740, US

(21) Appl. No.: 12/302,801

(22) PCT Filed: Jul. 25, 2007
(86) PCT No.: PCT/AU2007/001030

§ 371 Date: Nov. 27, 2008

(30) Foreign Application Priority Data
Jul. 25, 2006 (AU) 2006903973

(51) Int. Cl. B26D 5/12; B26D 7/00

(52) U.S. Cl. 83/639.1; 83/859

(57) ABSTRACT

The present invention relates to an apparatus for cutting vegetables of different sizes and densities in a quick, safe and efficient manner The apparatus embodied herein provides an automated cutting process requiring only one operator who need not apply any physical exertion during the cutting process, and need not place his or her hands in the vicinity of the blade, as is necessary in conventional cutting methods using saws, guillotines and the like. The speed of the cutting blade bearing down on the vegetable is adjustable by varying the air pressure to a cylinder which actuates movement of the blade. This is advantageous in that the speed of the blade can be changed to suit particular sizes and densities of vegetable. The use of pneumatics further provides an extremely swift blade motion which reduces the likelihood of bruising to the vegetable as well as inaccurate portioning. Furthermore, when using such equipment, the quality of the cut will not be impaired over significant periods of use.

### FIELD OF THE INVENTION

The present invention relates to a vegetable cutting apparatus and, in particular, to an apparatus for cutting large vegetables such as pumpkin or cabbage into smaller portions for use or sale.

### BACKGROUND OF THE INVENTION

Large vegetables, such as pumpkins, cabbage and lettuce, are currently sold either whole or in portions. The average purchaser is not likely to use a whole vegetable in one sitting or necessarily have space for storing vegetables of such large size. Therefore, large vegetables are sold in supermarkets and grocery stores in smaller portions, generally halves or quarters. Current practice for halving or quartering these vegetables is for supermarket or grocery store personnel to use large knives or guillotine-like blades to cut the vegetables. These existing cutting methods are effective, however, they are slow and cumbersome, and can be dangerous to the person handling the cutting equipment. Furthermore, portioning of the vegetables can be inaccurate due to human error.

Other known vegetable slicing devices have been used in an attempt to overcome these problems. For example, one such device involves the manual depression of a blade by a user, using a lever arrangement. Smaller vegetables, such as potatoes, are often cut using a device with an arrangement of rotating blades. However, this device in particular is generally not suitable for large vegetables such as pumpkins, and especially leaf vegetables that require a clean cut in order to be presentable to a purchaser and to minimise waste.

A further example of a manually actuated chopping device known to the present inventor is one which generally comprises a plunger with a spring tensioning device for actuating the plunger, and a blade associated with the plunger. The apparatus is operated by a user who depresses a lever which actuates the plunger/blade. Once the lever is released the spring return the plunger/blade to the starting position. The device also includes a housing and/or guards to protect the user and other persons in the vicinity from inadvertently placing a body part in the path of the blade. The housing can either be manually positioned or depressed and raised by the action of the lever.

There are several problems associated with such a device. Firstly, where springs are used in the actuation of the blade, wear and fatigue on the spring over extended periods of use becomes an issue. It has been found that over time the spring loses the stiffness required to retract the blade to a high enough position to enable a user to place a vegetable there beneath. When the spring is worn to this degree, it requires replacement, and this is an undesirable expense to the owner of the equipment. In any event, the use of such an actuation means may not provide the force required to slice through larger and more dense vegetables such as pumpkin.

Secondly, the quality and thickness of the cut imparted on the vegetable is related to speed and force of the blade. Accordingly, the cuts are required to be sharp and consistent in order to avoid vegetable bruising and damage. As mentioned, cutting devices using springs and the like lose consistency over time, and their speed and force is not something which can be easily controlled. Also, in an automated version of a cutting device, hydraulic mechanisms are not preferred as they have a tendency to leak oil. Any hydraulic oil leak would contaminate the food being cut and pose a risk to health.

Thirdly, there are cleaning issues associated with such devices. The smooth operation of such a device requires the guards and the plunger to have a complete range of motion and not be impeded by any build up of vegetable residue. In order to be cleaned, regular maintenance needs to be performed, including regular dismantling.

There is therefore a general need in the industry for a safe, automated vegetable cutting system, as opposed to manual systems which can be dangerous and suffer from the disadvantages mentioned above. Further, an automated system should have safeguards so as to protect the machine from over extending its range of motion, or being overloaded when cutting an object with say too high a density.

It is therefore an object of the present invention to overcome the aforementioned problems and to provide the public with a useful alternative.

### SUMMARY OF THE INVENTION

Therefore in one form of the invention there is proposed a vegetable cutting device, comprising:
a blade for cutting said vegetable into desired portions;
a ram attached to said blade;
a means for moving said ram vertically so as to cut the vegetable being placed underneath the blade; and
a means for a user to actuate said ram.

Preferably said means for moving said ram is a pneumatically operated cylinder.

Preferably said means for said user to actuate said ram is a dual hand control arrangement adapted to actuate said ram when said user retains a constant pressure on both of said hand controls.

Preferably said vegetable cutting device includes a pneumatic regulator adapted to maintain a constant desired air pressure.

Preferably said blade is comprised of stainless steel and includes a plurality of cutting surfaces to cut said vegetable into desired portions.

Preferably said device is assembled from two parts, whereby, said first part is a base comprising of a plurality of vertical legs and horizontal shelves, and said second part comprises of a structure supporting said cylinder, said ram, and said blade and a cutting surface horizontally opposed to the blade adapted to receive said vegetable being cut.

In preference said cutting surface is comprised of stainless steel.

Preferably said ram contains an attachment means adapted to attach said blade with said ram.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 illustrates a perspective view of the vegetable cutting apparatus in accordance with a first embodiment of the present invention;

FIG. 2 illustrates a schematic view of the pneumatic components and corresponding air hoses of the vegetable cutting apparatus of FIG. 1;

FIG. 3a illustrates a front view of the vegetable cutting apparatus of FIG. 1 prior to operation with the blade in a retracted position;

FIG. 3b illustrates a front view of the vegetable cutting apparatus of FIG. 1 during operation with the blade fully descended;

FIG. 3c illustrates a front view of the vegetable cutting apparatus of FIG. 1 after operation with the blade having returned to its retracted position;

FIG. 4a illustrates a top perspective view of the cutting blade forming part of the vegetable cutting apparatus of FIG. 1;

FIG. 4b illustrates an underside perspective view of the cutting blade of FIG. 4a;

FIG. 5a illustrates a front view of a vegetable cutting apparatus in accordance with a second and preferred embodiment of the invention, when the safety guard is open and the blade is in its raised position;

FIG. 5b illustrates a front view of the vegetable cutting apparatus of FIG. 5a when the safety guard is closed and the blade is in its descended position;

FIG. 6a illustrates a front perspective view of FIG. 5a; and

FIG. 6b illustrates a front perspective view of FIG. 5b.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention.

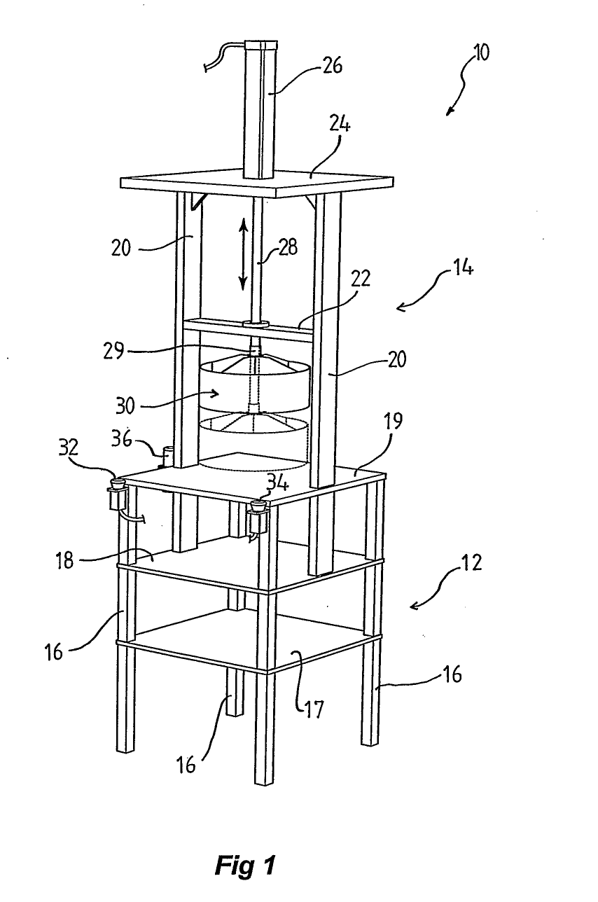

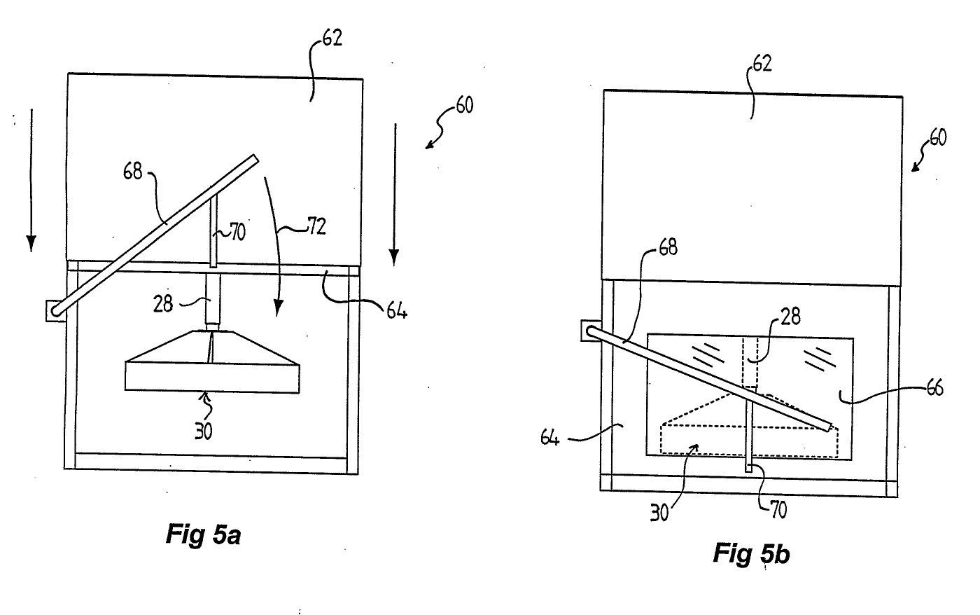

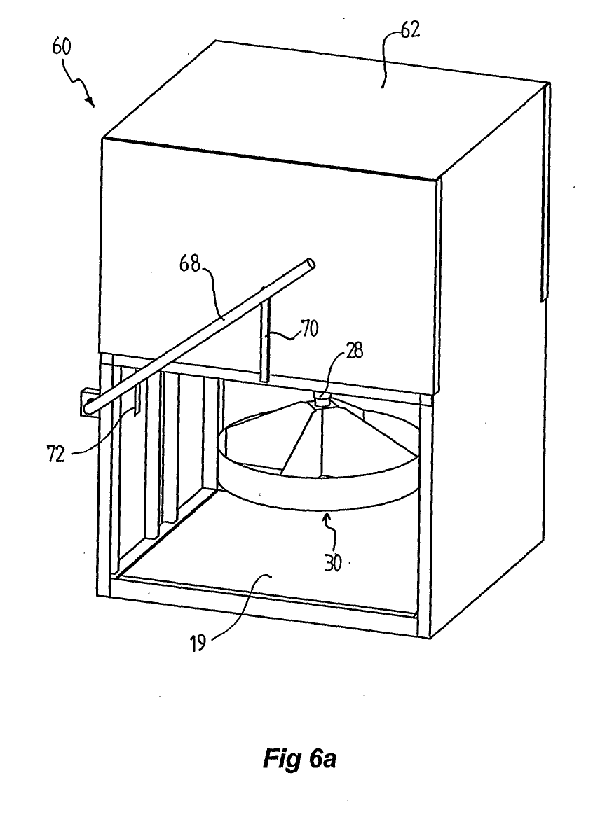

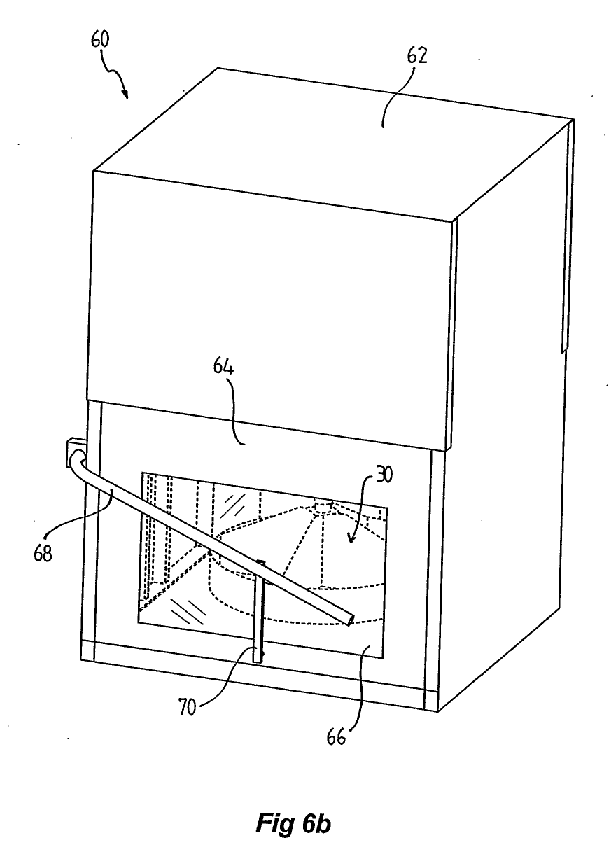

FIGS. 1-4 relate to a vegetable cutting device 10 in accordance with a first embodiment of the present invention, and FIGS. 5-6 illustrate a vegetable cutting device 60 in a preferred embodiment.

Turning firstly to FIG. 1, the vegetable cutting device 10 consists of a base 12 and a head unit 14. In the embodiment shown, the base 12 comprises four equally spaced legs 16 positioned at the corners of two spaced apart, horizontal, square shelves 17 and 18. The legs extend above the upper shelf 18 to support a square receiving frame (not shown) of substantially the same dimensions as shelves 16 and 17. The frame is configured to house and secure a horizontal, square cutting surface 19 which forms the lower part of the head unit 14. The cutting surface 19 includes two vertical stands 20 which extend upwardly and downwardly with respect to the surface 19. The downwardly extending portions extend to shelf 18 where they may be welded. The cutting surface can also be welded to the base frame once assembled.

It is to be understood that this is but one example of the plurality of possible frame variations. Shelf 18 could equally well form part of the head unit 14 whereby the base includes means to engage and secure both the shelf 17 and cutting surface 19. Another variation could be that the base 12 comprises three shelves and the head unit is configured to simply be placed on top of the top shelf, able to support itself there above, as per the preferred embodiment of the invention. A still further variation could be that the base 12 and head unit 14 form a single structure, however, for ease of transport and manoeuvrability it is desirable to have the head unit 14 and base 12 detachable. Provided that the head unit 14 is adequately supported, particularly during cutting operations, the way in which the head unit and base interact is not important.

As well as providing additional strength to the base 12, the shelves 17 and 18 provide a storage area for items such as an additional vegetable cutting blade for example.

The cutting surface 19 is preferably made from stainless steel. Those skilled in the art would realise that this metal is ideal with regards to cleanliness and hygiene, and also for ease of cleaning and rust prevention. Although not necessary, the entire device could be made from, or at least coated with stainless steel.

As mentioned, the head unit 14 includes two vertical stands 20. The portion of the stands which extend upwardly from the cutting surface 19 include a horizontal brace 22 for support. Mounted above the vertical stands 20 is a horizontal support shelf 24, having a pneumatic cylinder 26 mounted in its centre there above. The cylinder 26 is mounted such that the cylinder ram 28 extends downwardly therefrom. In an alternate configuration, pneumatic cylinder could be supported above the brace, thereby reducing the height of the apparatus. This is shown in the preferred embodiment.

The ram 28 is of a length which allows it to extend through the support shelf 24 as well as the brace 22 even when in a retracted position within the cylinder 26. The ram terminates at its lower end in a blade attachment means 29 which allows for attachment of different types of blade 30 to the ram 28. In the embodiment shown, the blade attachment means is in the form of an externally threaded boss adapted to engage an internally threaded female socket 31 associated with the blade 30. It is to be understood however that the blade attachment means could equally well be a snap lock fit or interference fit. In fact any means of attachment which ensures that the blade 30 will not become detached from the ram 28 during operation, whilst allow for quick and simple detachment for cleaning or changing of blades, can be used.

FIG. 1 further shows some of the pneumatic controls used to operate the vegetable cutter 10 which those skilled in the art would now appreciate involved extension and retraction of the ram causing the blade to slice down on a vegetable positioned there beneath.

In this embodiment, the method of operation is for two hand controls to be used, which ensure that the operator cannot place his/her hand(s) in the path of the descending blade 30. The pneumatic system is set up so that the operator must depress the left hand switch 32 and the right hand switch 34 simultaneously, and maintain constant pressure on the switches 32 and 34, in order to operate the device 10. If pressure is removed from either one or both of the switches, the blade will stop in its decent. If desired, the pneumatics may be set up so that in such circumstances the blade will automatically retract back to the starting position.

Dual hand controls eliminate the need for a retractable guard over the device 10 as the user is unable to place his/her hands proximate the blade during operation. This reduces the need for additional components, cleaning and maintenance. However, as will become obvious when viewing the preferred embodiment of the invention, such guards may well be implemented to provide for additional safety. In some countries of the world, it is an occupational health and safety regulation that such machines have guards installed.

An adjustable air pressure regulator 36 is also displayed in FIG. 1 allowing for the air pressure to the cylinder 26 to remain at a constant selected pressure. The adjustable air pressure allows for a vegetable to be cut efficiently and cleanly regardless of its size or density. A denser vegetable would require a greater cutting force or a quicker blade descent. Leafy vegetables, such as a cabbage, would require a slower, less forceful descent in order to minimise waste. The air pressure regulator may therefore be adjusted to suit particular needs. Although not shown, the device 10 could include a visual guide as to the required pressure for a certain variety and size of vegetable. Optimum pressures would obviously be determined through testing.

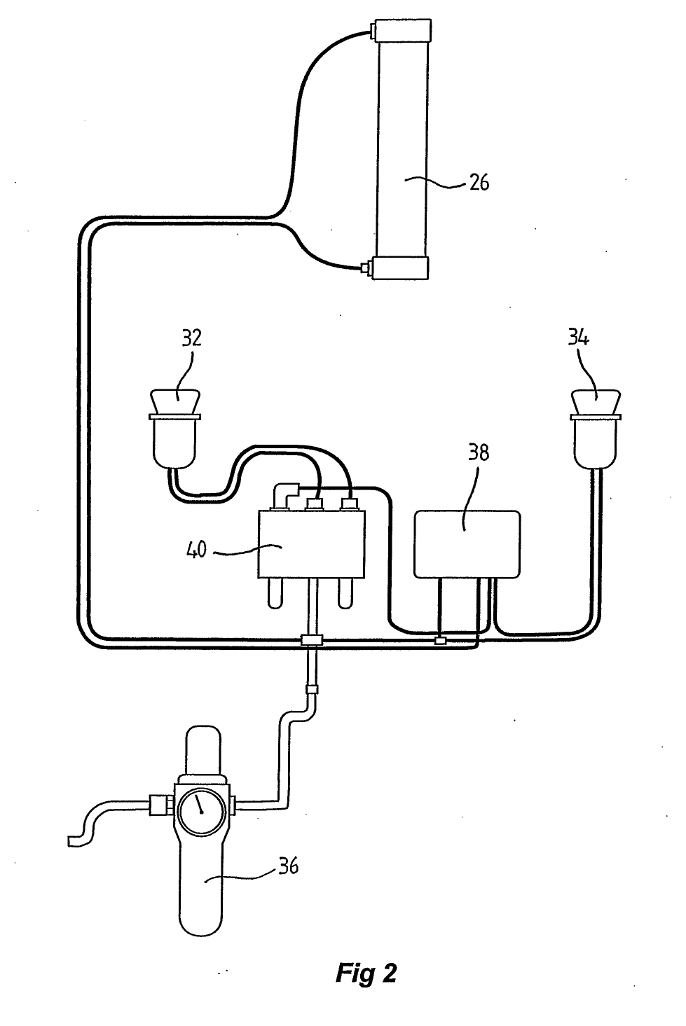

FIG. 2 illustrates an example of the arrangement and operation of the pneumatic components of device 10. As shown, the left hand switch 32 is a valve allowing for the flow of air travelling into the switch to exit once depressed, and into a controller 38 via a valve block 40. Similarly, the right hand switch 34 is used to allow the flow of air though the valve once depressed into the controller 38. The controller is programmed so that when the right hand switch is pressed, and the left hand valve is open, air is allowed to flow to the cylinder 26 to thereby actuate the ram 28. This causes the blade to descend on the vegetable and thereby cut it. Once either one of the valves 32 or 34 are closed, air is passed to the cylinder 26 to thereby retract the ram 28 and hence the blade 30.

The regulator 36 regulates the flow of air from a compressor or alternate air feed and allows the flow of constant pressure air to the valve block 40. In doing so it provides a safeguard against the cylinder ram 28 from over travelling or over exerting itself. The regulator 36 may also include a lubricating capability for more efficient operation of the valves and cylinder. Other safety mechanisms can be incorporated into the valve block 40 preventing, for example, the user from tying down one of the switches and using the device 10 with only one hand.

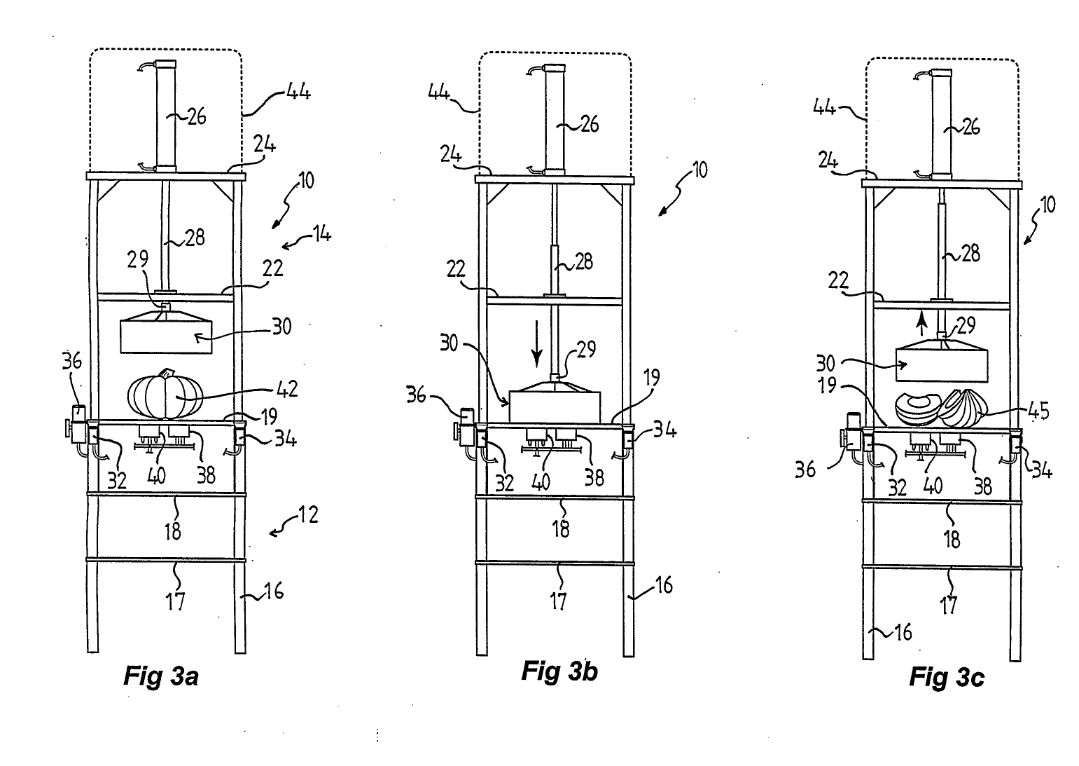

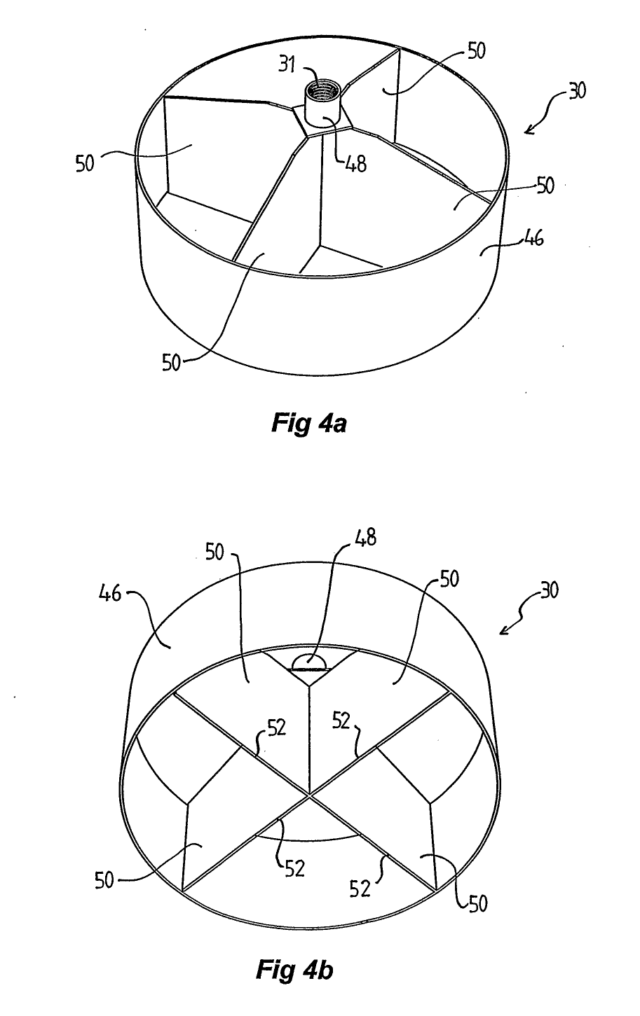

FIGS. 3a, 3b and 3c show the vegetable cutting device 10 in its three stages of operation. FIG. 3a shows a vegetable 42, shown in this embodiment to be a pumpkin, placed on the cutting surface 19 in position underneath the cutting blade 30. Also shown in this figure is an example of a cylinder guard 44, used to support and protect the cylinder 26. FIG. 3b displays the device 10 when the user has pushed down on both the left and right hand switches 32 and 34 respectively, until the blade 30 has descended fully and thereby sliced the vegetable 42 FIG. 3c illustrates the device 10c once the user has released the switch(es) and the blade has retracted to its original position beneath the brace 22. The vegetable is left cut in portions 45 the number and shape of the portions depending on the type of blade selected. The user may then remove the cut portions from the cutting surface 19 and if desired place another vegetable into the device and repeat the cycle.

FIGS. 4a-4b show but one embodiment of a cutting blade 30. The blade 30 includes an outer ring 46 and an attachment receptacle 48 at its centre defining the internal socket 31 adapted to engage the cylinder ram 28. Extending between the outer ring 46 and the central receptacle 48 are four equally radially disposed blades 50. In the embodiment shown, the blades are configured to cut a vegetable 42 into quarter portions 45. As mentioned, other blade arrangements could be used, such as two aligned blades for cutting the vegetable into halves, three radially disposed blades for cutting into thirds, a matrix of blades for cutting into square portions, or an asymmetric arrangement for cutting the vegetable into different sized portions, such as a half and two quarters. The outer ring 46 could be made to be square, oval or rectangular shaped instead, depending on the shape of the vegetable being cut.

It may be that the cutting blade may include suitably positioned slots enabling individual blades to be inserted in different geometrical arrangements to control the cutting footprint. The actual cutting edge 52 of each blade can be seen most clearly in FIG. 4b. The thickness and chamfer on the cutting edges may vary depending on the strength required of the blade to cut the various density vegetables. The blades may also include different types of cutting edges to suit different vegetables. The blades may also be serrated or posses other desirable configurations. The vertical height of the blades 50 and the ring 46 is also dictated by the strength required to cut the desired vegetable. The blade 30 is preferably made from stainless steel for ease of cleaning and maintaining hygiene standards.

A preferred embodiment of the present invention is illustrated in FIGS. 5a-5b and 6a-6b. In particular, a vegetable cutting apparatus 60 is shown in the form of a head unit adapted to be supported above a suitable base (not shown), or alternatively, on a ground surface. Essentially, the vegetable cutting apparatus 60 includes the same working components as that of apparatus 10, but includes an alternate means of actuating the pneumatic cylinder 28, as well as having improved safety features.

The working components in apparatus 60 are enclosed within an outer cubical housing 62 which includes front and rear safety guards 64 moveable between an upper position (shown in FIGS. 5a and 6a) allowing vegetables to be placed inside the housing, and a lower position (shown in FIGS. 5b and 6b) preventing access to the internal components. Only the front guard is shown as the rear guard is identical. Each safety guard 64 is in the form of slideable door having a transparent screen 66 allowing an operator to view the cutting process from outside the housing 62 when the guards are down.

A substantially U-shaped lever 68 is rotatably mounted to one side of the housing 62 such that it extends horizontally therealong, and whose perpendicular ends extend across the front and rear of the housing 62. The axis of rotation when viewing from apparatus from the front or rear is therefore the axis extending through the mounted horizontal portion. The front and rear portions of the lever extend approximately three quarters across the length of the housing 62, and are rotatably attached proximate their ends to an upper end of a vertical rod 70. The lower end of the rod 70 is fixedly attached to a surface of the guard 64 below the screen 66. Therefore, the skilled addressee will appreciate that when the lever is turned clockwise as depicted by arrow 72 in FIG. 5a, the guards 64 will move simultaneously downwards, and when the lever is turned anticlockwise, the guards will move simultaneously upwards.

Although the internal components of apparatus 60 are not shown, they are substantially the same as in apparatus 10. Therefore, apparatus 60 includes a cutting blade 30 that is vertically moveable between two positions through actuation of a pneumatic cylinder 26 mounted to a brace 22 above a cutting surface 19, and a pneumatic control system including a valve block 40, a control valve 38, and adjustable pressure regulator 36. However, the pneumatic arrangement differs slightly in that once the safety guards are closed, the cutting process is completely automated and does not require the pressing of any switches or the like.

In particular, either one or both of the safety guards 64 includes a pneumatic switch or valve (not shown) mounted internally to the housing 62 which is activated when the guards are not in their fully closed position. The pneumatic system is set up so that when this valve is not open, that is, when the guards are lowered, actuation of the blade is automatic. Those skilled in the art would therefore realise that in simply lowering the safety guards to a fully closed position, the cutting process is actuated.

Should the door be opened at any time during the cutting process, the valve associated with the guard 64 will open and the control valve 38 will prevent further downward movement of the ram 28 and, if desired, cause the ram 28 to retract as per the first embodiment. A detailed schematic of this pneumatic system is not depicted in the Figures as it does not depart significantly from that of the first embodiment and should be understandable to those skilled in the art.

In preference vertical movement of the safety guards is aided using a further pneumatic cylinder (not shown) mounted to one side of the central pneumatic cylinder 28 on the same brace 22. This pneumatic cylinder is mounted so that its internal ram extends upwardly during operation rather than downwardly. The safety guards are not directly connected to the cylinder but are coupled thereto by way of a connection between the cylinder ram and the portion of the lever mounted horizontally alongside the housing 62. Those skilled in the art would realise that by rotating this portion of the lever 68, the safety guards will open and close. The ram of the further cylinder is coupled to this portion in such a way so as to cause rotation thereof when actuated. For example, there may be two connecting arms (not shown) which extend downwardly alongside the cylinder and which are coupled to the ram so that they move vertically therewith. At their opposed lower ends, the connecting arms are coupled to the horizontal lever through slots 74 in the housing 62 in such a way that when the ram is actuated to move upwardly, the lever rotates anticlockwise, and when the ram is actuated to move downwardly, the lever rotates in a clockwise direction.

The pneumatic system is preferably arranged so that as soon as a downward force is applied to the lever by an operator, the pneumatic cylinder associated therewith is actuated to move the safety guards downwards without any further effort from the operator. Then, when the door has fully closed, the blade descends, cuts the vegetable, and is subsequently raised. Once this operation is complete, the control valve is configured to actuate the safety guard cylinder once again, thereby causing anticlockwise rotation of the lever and raising the safety guards so that the portioned vegetable may be removed. Therefore in one action by the operator, the entire cutting process is undertaken in a safe and efficient manner.

It is to be understood that the extent of automation is not intended to be limited to that which is embodied herein. For example, in the vegetable cutting apparatus 60, once the cutting action has taken place, the door need not automatically open. It may remain closed until such time that an operator applies an anticlockwise force on the lever, initiating the pneumatic cylinder associated therewith to raise the guards. The pneumatic system may therefore be configured and tailored to suit individual requirements. Once again, the blades may be dismantled easily for cleaning and replacement.

The present invention therefore provides an apparatus for cutting vegetables of different sizes and densities in a quick, safe and efficient manner. The apparatus embodied herein provides for an automated system requiring only one operator who does not need to apply any physical exertion during the cutting process and need not place his or her hands in the vicinity of the blade, as is necessary in conventional cutting methods using saws, guillotines and the like. The speed of the cutting blade bearing down on the vegetable is adjustable by varying the air pressure to the cylinder which actuates movement of the blade. This is advantageous in that the speed of the blade can be changed to suit particular sizes and densities of vegetable. The use of pneumatics further provides an extremely swift blade motion which reduces the chance of bruising to the vegetable and inaccurate portioning. Furthermore, when using such equipment, the quality of the cut will not be impaired over significant periods of use.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the fall scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A cutting apparatus characterised by:
a cutting surface upon which at least one item to be cut is adapted to be placed;
at least one cutting blade moveable between a first position in which a cutting edge thereof is positioned away from said item, and a second position in which said cutting edge has moved a distance towards the cutting surface sufficient to have effected a cut at least partially through said item; and
a regulator for controllably adjusting the speed of movement of said cutting blade to thereby facilitate cutting of items having variable densities.

2. A cutting apparatus as in claim 1 wherein movement of said blade between said first and second positions is actuated using a pneumatic cylinder.

3. A cutting apparatus as in claim 2 wherein said regulator is in the form of an adjustable pressure regulator for controllably varying air pressure available to said pneumatic cylinder.

4. A cutting apparatus as in claim 2 wherein said cutting blade is removably attachable to an external end of a ram associated with said pneumatic cylinder.

5. A cutting apparatus as in claim 4 wherein said cutting surface is horizontal.

6. A cutting apparatus as in claim 5 wherein said cutting apparatus includes a frame for supporting said pneumatic cylinder a predetermined distance above said horizontal cutting surface, said distance substantially corresponding with the combined length of said ram and the attached blade.

7. A cutting apparatus as claim 4 wherein said at least one cutting blade is fixed within a housing including means of attachment to said ram.

8. A cutting apparatus as in claim 1 wherein said at least one cutting blade is arranged to cut said item into a plurality of portions.

9. A cutting apparatus as in claim 1 wherein said at least one cutting blade is arranged to cut said item in half.

10. A cutting apparatus as in claim 1 wherein said at least one cutting blade is arranged to cut said item in thirds.

11. A cutting apparatus as in claim 1 wherein said at least one cutting blade is arranged to cut said item in quarters.

12. A cutting apparatus as in claim 1 wherein said item is a vegetable.

13. A cutting apparatus for size reduction of foodstuffs, said cutting apparatus characterised by:
a horizontal cutting surface upon which at least one item is to be placed;
an outer frame including at least one horizontal surface positioned a predetermined distance above said cutting surface;
an inverted pneumatic cylinder supported above said horizontal surface, said cylinder including an internal ram moveable between a retracted and extended position therebelow;
a cutting device removably attachable to a lower end of said ram, said cutting device including at least one cutting blade arranged such that when said pneumatic cylinder is actuated, the ram moves from said retracted to said extended position urging said cutting device downwards toward said cutting surface and thereby effecting a cut at least partially through said item; and
an air pressure regulator for controllably varying the speed at which said ram moves between said extended and retracted positions, thereby facilitating cutting of foodstuffs having variable densities.

14. A cutting apparatus as in claim 13 further including a pneumatic control system involving at least a first valve, a second valve, and a control valve for ensuring that said ram remains in or returns to said retracted position unless both the first and second valves are open.

15. A cutting apparatus as in claim 13 further including an outer housing which substantially encloses said frame, cutting surface, pneumatic cylinder and cutting device.

16. A cutting apparatus as in claim 15 wherein said outer housing includes at least one door moveable between an open position in which said cutting surface is accessible and a closed position in which access to said cutting surface is prevented.

17. A cutting apparatus as in claim 16 wherein said at least one door is moveable by a second pneumatic cylinder which is activated through rotation of an external manual lever operatively coupled to a ram of said second pneumatic cylinder.

18. A cutting apparatus as in claim 17 further including a pneumatic control system involving at least a first valve associated with said at least one door, and a control valve for ensuring that the ram of said first pneumatic cylinder remains in or returns to said retracted position when the door is not in said closed position.

19. A cutting apparatus as in claim 18 wherein said pneumatic control system is configured so that when said manual lever is rotated, the pneumatic cylinders are operated to sequentially move the door from said open to said closed position, move the cutting device from said retracted to said extracted position, move the cutting device back to said retracted position, and move the door from said closed to said open position.

20. A cutting apparatus as in claim 3 wherein said cutting blade is removably attachable to an external end of a ram associated with said pneumatic cylinder.
